(19) United States
(12) Patent Application Publication
(10) Pub. No.: US 2004/0093919 A1
(43) Pub. Date: May 20, 2004

(54) Vehicular latch and lift assembly and controls for operating same

(76) Inventors: Robert B. Mooney, Farmington Hills, MI (US); John G. Zeabari, Highland, MI (US); Jason Abraham, Canton, MI (US); Thomas L. McGettrick, Plymouth, MI (US); Giovanni Grillo, Windsor (CA)

Correspondence Address: Robin W Asher, Clark Hill, Suite 3500, 500 Woodward Avenue, Detroit, MI, 38266-3435, US

(21) Appl. No.: 10/469,398

(22) PCT Filed: Feb. 25, 2002
(86) PCT No.: PCT/CA02/00236

(51) Int. Cl. E05B 53/00

(52) U.S. Cl. 70/263; 49/262

(57) ABSTRACT

A latch assembly (100) releases a closure structure (12) of a motor vehicle (10). The latch assembly includes a latch housing (37). A latch (28) for releasing the closure structure (12), allowing the closure structure to move toward an open position, is housed within the latch housing. A voltage regulator (46) is electrically connected to the latch (28) and provides power to the latch (28). Also, the latch assembly includes a microprocessor (44) that is electrically connected to the voltage regulator (46) to receive the power supplied by the voltage regulator, wherein the microprocessor (44) and the voltage regulator (46) are housed within the latch housing (37).

### FIELD OF THE INVENTION

The invention relates to a vehicular latch assembly. More specifically, the invention relates to an automated vehicular latch and lift assembly for a closure structure and a control mechanism for operating same.

### BACKGROUND OF THE INVENTION

Many systems are required to manufacture a motor vehicle. As technology progress, the electronic content of these systems increases. Oftentimes, these systems are developed, designed and manufactured with little communication with other groups designing other systems. This results in redundant controls and electrical paths through which power and control signals must travel.

In the area of closure assemblies, liftgates, sliding doors, windows and pivotal doors, electronic control is becoming more pervasive. In many instances, these systems are motorized to obviate manual operations. In other instances, e.g., liftgates, the automation of the liftgate may not be complete because it is designed to be a power assist assembly.

Control systems for these assemblies must be mounted to the motor vehicle. This adds cost. Further, the control system must be in communication with the manual system so that it can determine when power assist instructions are to be sent between the liftgate actuator, or latch, and the control system for the motor. This adds cost due to inventory and assembly. Additional weight to the motor vehicle is also incurred.

### SUMMARY OF THE INVENTION

According to one aspect of the invention, there is provided a latch assembly that releases a closure structure of a motor vehicle. The latch assembly includes a latch housing. A latch for releasing the closure structure allowing the closure structure to move toward an open position is housed within the latch housing. A voltage regulator is electrically connected to the latch and provides power to the latch. Also, the latch assembly includes a microprocessor that is electrically connected to the voltage regulator to receive the power supplied by the voltage regulator, wherein the microprocessor and the voltage regulator are housed within the latch housing.

Other features and advantages of the present invention will be readily appreciated as the same becomes better understood after reading the subsequent description when considered in connection with the accompanying drawings.

### BRIEF DESCRIPTION OF THE DRAWINGS

FIG. 1 is a top schematic view of a motor vehicle incorporating one embodiment of the invention;

FIG. 2 is an exploded perspective view of one embodiment of the invention;

FIG. 3 is a schematic view of one embodiment of the invention;

FIG. 4 is a schematic view of a second embodiment of the invention;

FIG. 5 is a schematic view of a first embodiment of a manual latching system incorporating the invention;

FIG. 6 is a schematic view of another embodiment of a manual latching system incorporating the invention;

FIG. 7 is a schematic view of the first embodiment in a powered latching system incorporating the invention;

FIG. 8 is a schematic view of a third embodiment of a manual latching system incorporating the invention;

FIG. 9 is a schematic view of a fourth embodiment of a manual latching system incorporating the invention;

FIG. 10 is a schematic view of a fifth embodiment of a manual latching system incorporating the invention;

FIG. 11 is a schematic view of a sixth embodiment of a power latching system incorporating the invention;

FIG. 12 is a schematic view of a seventh embodiment of a manual latching system incorporating the invention;

FIG. 13 is a schematic view of an eighth embodiment of a power latching system incorporating the invention;

FIG. 14 is a schematic view of a ninth embodiment of a manual latching system incorporating the invention; and

FIG. 15 is a schematic view of a tenth embodiment of a power latching system incorporating the invention.

### DETAILED DESCRIPTION OF THE INVENTION

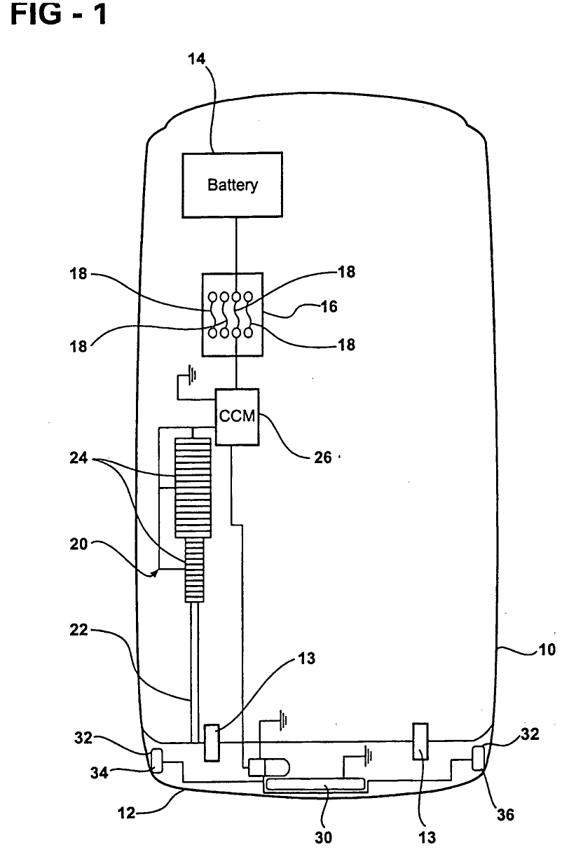

Referring to FIG. 1, a motor vehicle 10 is shown in plan outline. While the motor vehicle 10 is shown to be a vehicle having a particular closure structure, i.e., a rear liftgate 12, it should be appreciated by those skilled in the art that the closure structure 12 for closing the vehicle aperture might be a hatch or sliding door. The liftgate 12 uses two hinges 13 to maintain a pivoting relationship with the motor vehicle 10.

The motor vehicle 10 includes a battery 14. The battery 14 is a standard 12 volt battery known in the art. The battery 14 is connected to a fuse assembly 16 that includes a plurality of fuses 18, as is well known in the art. The battery 14 supplies a current to many components of the motor vehicle 10. FIG. 1 shows a single connection from the battery 14 for purposes of simplicity.

The liftgate 12 is pivotable between a closed position, as is shown in FIG. 1, and an open position. A power assist mechanism 20 is electrically connected to the battery 14 and mechanically connected to the liftgate 12. The power assist mechanism 20 provides power through a connecting assembly 22 to lift and lower the liftgate 12. In the embodiment shown in FIG. 1, the connecting assembly 22 is a rod 22. The power assist mechanism 20 may provide sufficient power to independently open and close the liftgate 12 or, in the alternative, may provide only enough power to assist an operator of the liftgate 12 when opening and closing the liftgate 12. The power assist mechanism 20 is shown graphically to include at least two gears 24. It should be appreciated by those skilled in the art that any number of gear configurations might be incorporated into the power assist mechanism 20. An example of a suitable power assist mechanism 20 is described in WO 00/68538, which is hereby expressly incorporated by reference.

A central control module 26 is electrically connected between the battery 14 and the power assist mechanism 20. The central control module 26 receives inputs from a power latch 28, discussed in greater detail subsequently. The power latch 28 is electrically and/or mechanically connected to a handle 30. The handle 30 is operated by a user to open or close the liftgate 12.

Operably connected to the power latch 28 are two sensors 32. The two sensors 32 are a left tape switch 34 and a right tape switch 36. The left 34 and right 36 tape switches are used to prevent the power assist mechanism 20 from closing the liftgate 12 when an obstacle is in the way. More specifically, an obstacle will close either of the tape switches 34, 36 which will, in turn, indicate to the central control module 26 that complete closure of the rear liftgate 12 is not possible.

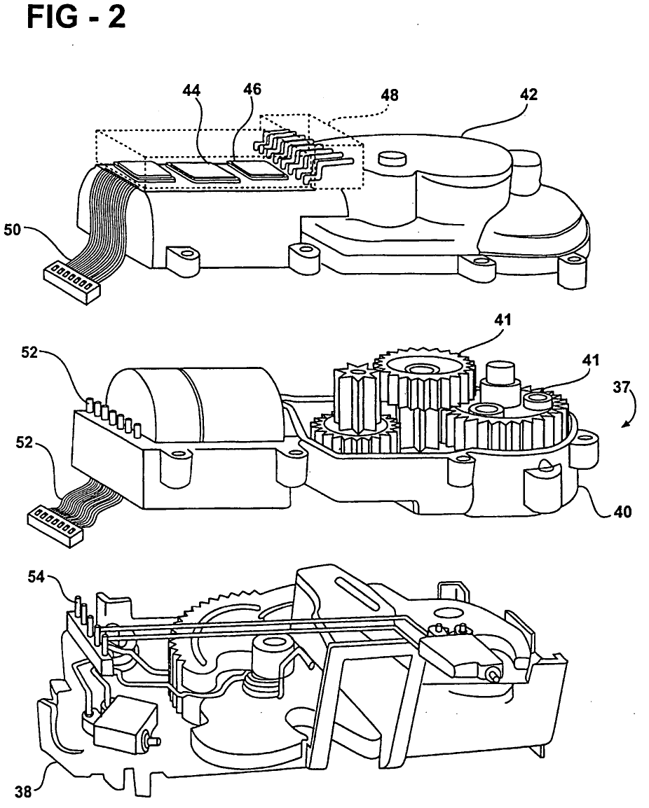

Referring to FIG. 2, an exploded perspective view of one embodiment of the invention, a latch assembly, is shown. The latch assembly is more accurately described as a cinch/release power latch because it includes a release capability and a cinching capability when the liftgate 12 is being opened and closed, respectively. Examples of a latch assembly, comprising a latch and actuator are discussed in WO 00/49252 and WO 00/33445 and are hereby expressly incorporated by reference.

The latch assembly 100 includes a housing 37 that covers the latch 28. The housing 37 includes a base 38, an intermediate support 40 and a latch cover 42. The intermediate support 40 matingly engages the base 38. The intermediate support 40 houses a motor 39 and the majority of a set of gear linkages 41. The motor 39 is used to release the cinch allowing the liftgate 12 to move from its closed position toward its open position. The latch cover 42 is secured to the intermediate support 40. A microprocessor 44 and voltage regulator 46 are secured to the latch cover 42. A vehicle connector 48 allows the power latch 28 to be electrically connected to the electrical system (or a portion of it as shown in FIG. 1) of the motor vehicle 10. Electrical connectors 50, 52 and 54 extend through the power latch 28 allowing electrical communication therethrough.

The base 38, intermediate support 40, and latch cover 42 combine to form a latch housing. The latch housing 38, 40, 42 houses the mechanical gear linkages 41 as well as the microprocessor 44 and the voltage regulator 46. The latch 28 becomes a node in the overall electrical/communication system of the motor vehicle 10. The power latch 28 is a node having computational and voltage control functionality. Thus, the signal and power requirements delivered to the power latch 28 are greatly simplified. It should be appreciated by those skilled in the art that the microprocessor 44 and the associated electronics may be housed anywhere within the power latch 28.

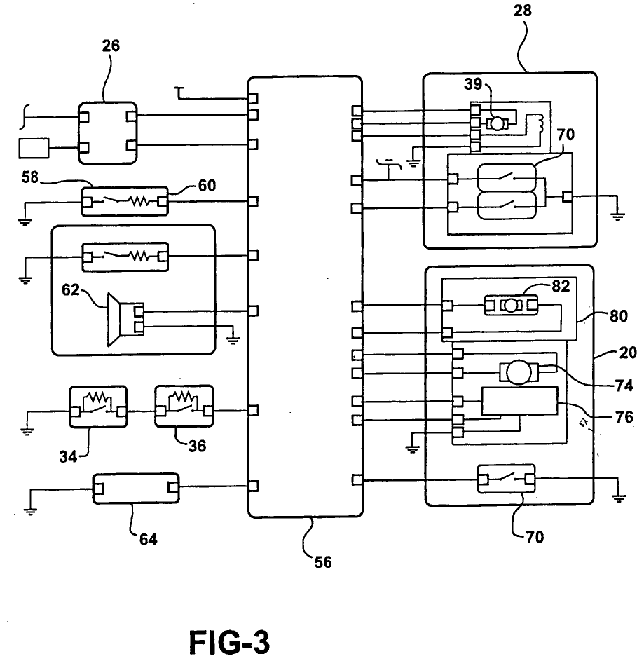

Referring to FIG. 3, a block diagram of a power liftgate module 56 is shown connected to many peripheral elements. The power latch 28, the power assist mechanism 20, the central control module 26 are all connected to the power liftgate module 56. Further, a liftgate front switch 58 is connected thereto. The liftgate front switch 58 allows an operator to open and close the liftgate 12 when the operator is located in the driver seat of the motor vehicle 10. A handle switch 60 and a liftgate chime 62 are also connected to the power liftgate module 56. In some instances, the handle 30 on the liftgate 12 will merely actuate the electrical switch 60. In other words, the handle will have no mechanical latching capability. Therefore, the electrical switch 60 will be required. Conversely, should the handle 30 be a standard mechanical handle and release mechanism, the handle switch 60 will not be required.

A temperature sensor 64 is electrically connected to the power liftgate module 56. The temperature sensor 64 provides information regarding the ambient temperature allowing compensation for any differences in pushrod functionality affected thereby. The pushrod, illustrated as connecting assembly 22 in FIG. 1, is a hydraulic device. When the temperature decreases, the fluid within the pushrod has a reduced lifting capability because, according to gas laws, the pressure of the same amount of gas in the same volume decreases as temperature decreases.

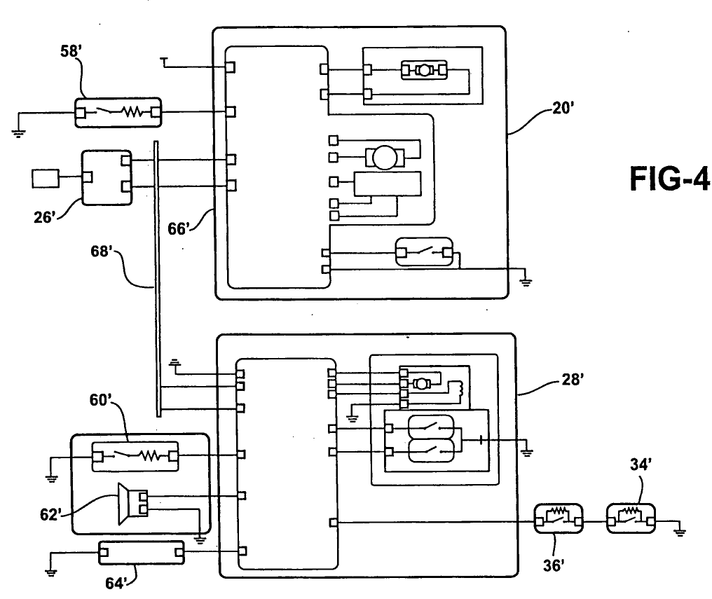

Referring to FIG. 4, wherein like primed numerals represent similar elements, a second embodiment of power assist mechanism 20 is shown. In this second embodiment, the power liftgate module 56 of the first embodiment is incorporated directly into the gear motor assembly 66 and the latch assembly 28′. A communication bus 68 provides communication between the gear motor assembly 66 and the latch 28′. It should be appreciated that both the latch assembly 28′ and the power assist mechanism 20′ are incorporated with the housing 37 (not shown in this Figure).

The power assist assembly 20′ allows the liftgate 12′ to be cinched to be securely closed. The power assist assembly 20′ includes a liftgate motor 74. The liftgate motor 74 moves the liftgate 12′ between its open and closed positions. A Hall Effect sensor 76 is disposed adjacent the liftgate motor 74 to identify where in its rotation the liftgate motor 74 is. A liftgate full open switch 78 is a limit switch that disengages power to the liftgate motor 74 when the liftgate 12′ is at its fully open position.

The power assist assembly 20′ also includes an engaging actuator 80. The engaging actuator 80 includes an engaging motor 82. The engaging motor 82 engages or cinches the liftgate 12′ with the motor vehicle. More specifically, once the liftgate 12′ abuts against its framed opening of the motor vehicle, the engaging motor 82 moves the latch mechanism such that the liftgate 12′ is no longer free to move, regardless of the activity of the liftgate motor 74 or what is being done manually.

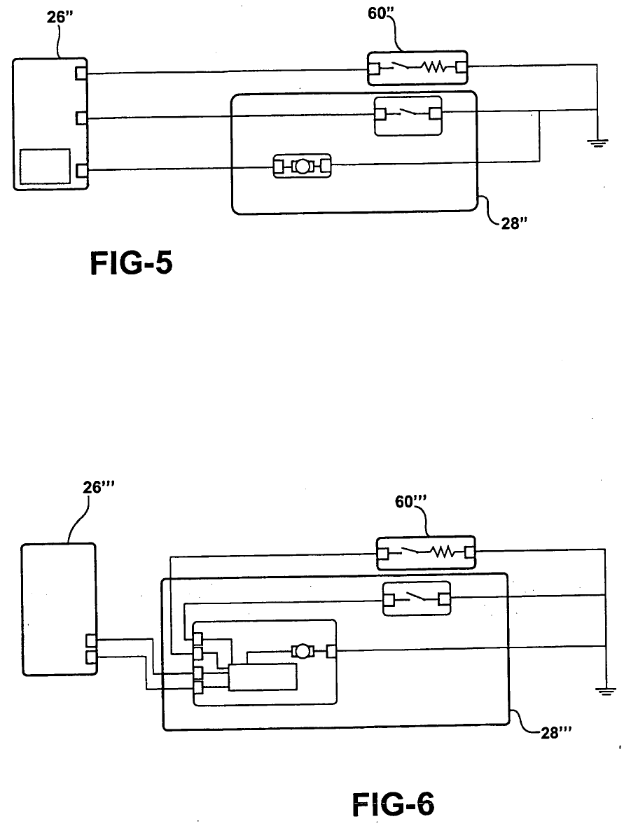

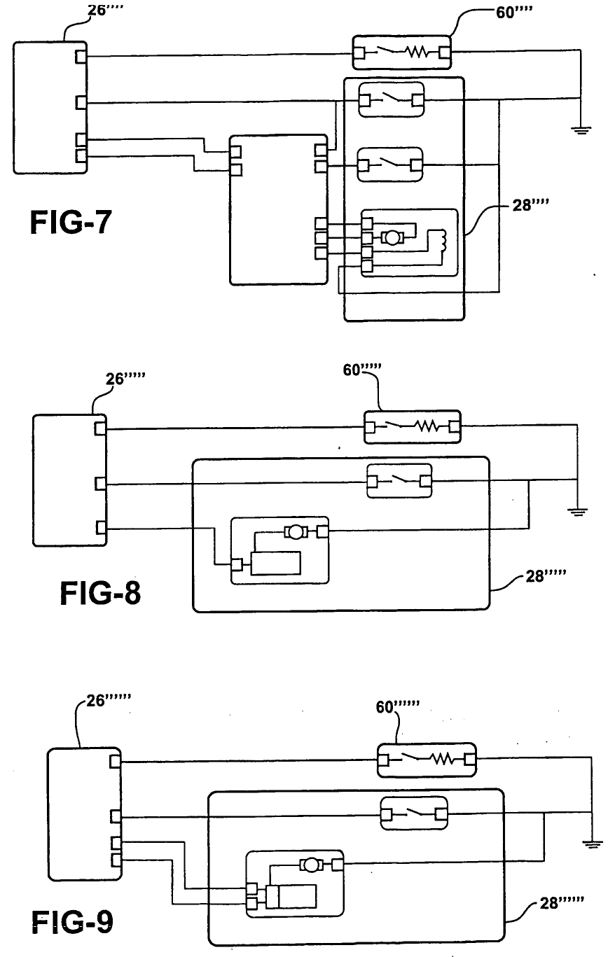

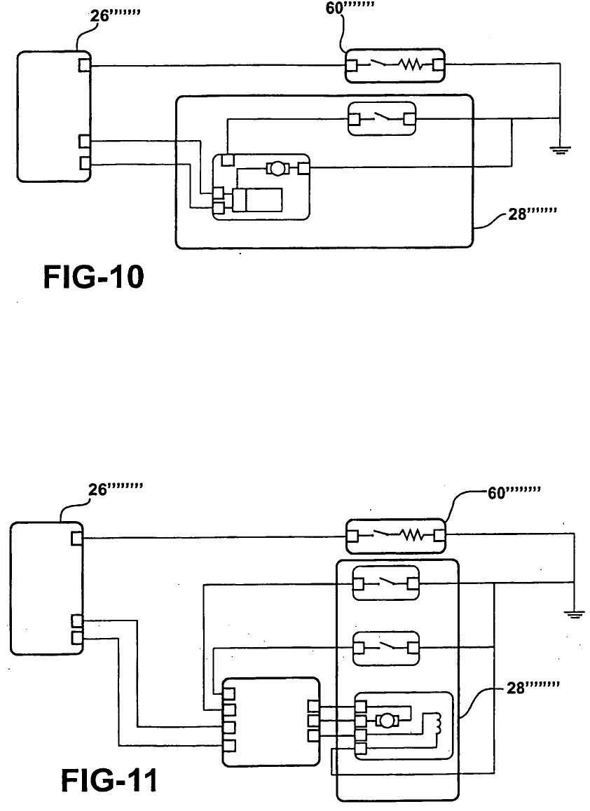

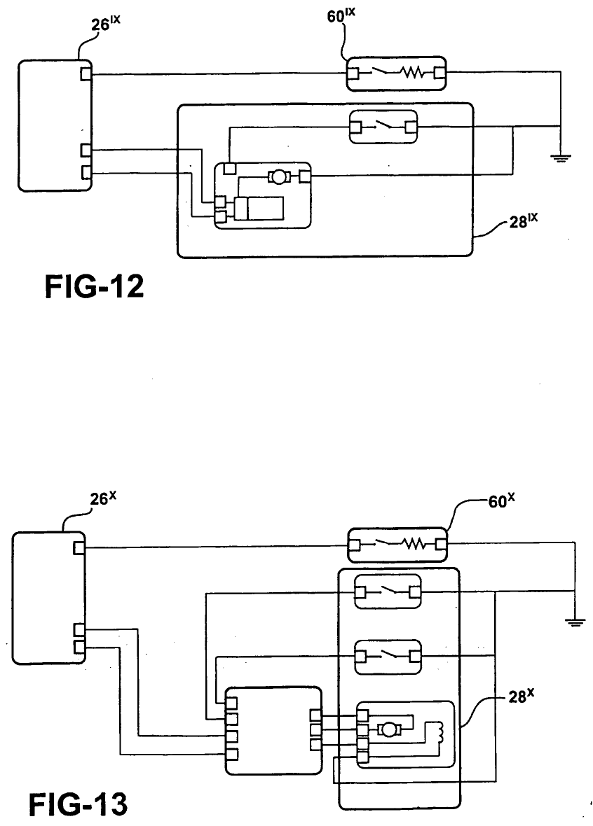

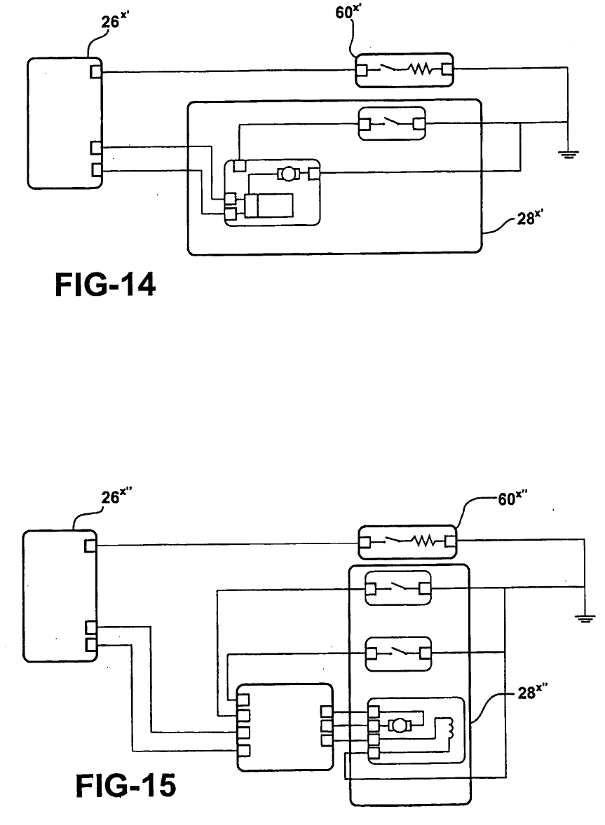

The communication bus 68 may include a CAN bus having defined transmission and reception ports. Alternatively, the communication bus 68 may be a multiplexed line that sends data over a single transmission/reception line. Other protocols may be employed to communicate between the various sensors and the central control module 26′, the latch assembly 28′ and the power assist mechanism 20′. FIGS. 5 through 15 illustrate various latching configurations. In all of the figures, the central control module 26 is shown electrically connected to a liftgate release mechanism to having a handle switch 60 and an ajar switch 70. Each Figure represents either a manual configuration, i.e., a system requiring a manual latch, or a power configuration wherein the latching function is electrically controlled and operated.

With specific reference to FIG. 6, the central control module 26′″ communicates through a CAN bus 68′″ with the latch assembly 28′″. The motor 39′″ is connected, in parallel with the liftgate handle 60′″ and the ajar switch 70′″, between a driver 72 for the motor 39′″ and the liftgate 12′″, i.e., ground.

The present invention has been described in an illustrative manner. It is to be understood that the terminology, which has been used, is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A latch assembly for a closure structure of a motor vehicle, said latch assembly comprising:
a latch housing;
a latch for releasing the closure structure allowing the closure structure to move toward an open position;
an actuator operably connected to said latch to provide powered operation of said latch, said latch and actuator housed within said latch housing;
a voltage regulator electrically connected to said latch and providing power to said latch; and
a microprocessor electrically connected to said voltage regulator to receive the power supplied by said voltage regulator, wherein said microprocessor and said voltage regulator are housed within said latch housing.

2. A latch assembly as set forth in claim 1 wherein said microprocessor is electrically connected to a central control module for the motor vehicle.

3. A latch assembly as set forth in claim 2 wherein said latch housing includes a base for securing base components thereto and for securing said latch housing to the closure assembly.

4. A latch assembly as set forth in claim 3 wherein said base includes a base connection allowing said microprocessor to electrically communicate with a portion of said base components.

5. A latch assembly as set forth in claim 4 wherein said latch housing includes a latch cover for covering said latch and said microprocessor within said latch housing.

6. A latch assembly as set forth in claim 5 wherein said latch cover includes a cover connection allowing said microprocessor and said voltage regulator to electrically communicate with said latch assembly.

7. A latch assembly as set forth in claim 6 wherein said latch housing includes an intermediate support for securing gears and a motor within said latch housing.

8. A latch assembly as set forth in claim 7 wherein said intermediate support includes an intermediate connection allowing said microprocessor to electrically communicate with said portion of said base components and said motor.

9. A latch assembly as set forth in claim 8 wherein said intermediate and cover connections each include a flexible cable.

10. A latch assembly as set forth in claim 9 wherein said base includes a base pin for receiving said flexible cable thereon.

11. A latch assembly as set forth in claim 10 wherein said intermediate support includes an intermediate pin for receiving said flexible cable thereon.

12. A latch assembly as set forth in claim 9 latch housing includes a base for securing base components thereto and for securing said latch housing to the closure assembly.

13. A control assembly for a latch including a latch housing and a handle, said control assembly comprising:
a sensor connected to the handle, said sensor generating and transmitting an open signal when the latch is manually operated;
a microprocessor electrically connected to said sensor for receiving said open signal and for generating a power signal;
a voltage regulator electrically connected to said microprocessor for receiving power from an external source, regulating the power to be a predetermined voltage, and transmitting the predetermined voltage to said microprocessor; and
an output port electrically connected to said microprocessor, said output port being connectable with a motor as a function of said power signal generated by said microprocessor.

14. A control assembly as set forth in claim 3 wherein said microprocessor, said voltage regulator and said output port are housed with the latch housing.

15. A control assembly as set forth in claim 4 wherein said output port is electrically connected to a central control module.

16. A latch assembly as set forth in claim 2 wherein said latch housing includes a base for securing base components thereto and for securing said latch housing to the closure assembly.

17. A latch assembly as set forth in claim 3 wherein said base includes a base connection allowing said microprocessor to electrically communicate with a portion of said base components.

18. A latch assembly as set forth in claim 4 wherein said latch housing includes a latch cover for covering said latch and said microprocessor within said latch housing.

19. A latch assembly as set forth in claim 5 wherein said latch cover includes a cover connection allowing said microprocessor and said voltage regulator to electrically communicate with said latch assembly.

20. A latch assembly as set forth in claim 6 wherein said latch housing includes an intermediate support for securing gears and a motor within said latch housing.
